(19) United States
(12) Patent Application Publication
(10) Pub. No.: US 2021/0065934 A1
(43) Pub. Date: Mar. 4, 2021

(54) ELECTRICAL CABLE

(71) Applicant: TE CONNECTIVITY CORPORATION, Berwyn, PA (US)

(72) Inventors: Craig Warren Hornung, Harrisburg, PA (US); Vincent Reydams, Harrisburg, PA (US); Kevan Tran, Webster, MA (US); Steven Rennie, North Grafton, MA (US); Paul Savage, Millville, MA (US); Paul Leo Grant, Auburn, MA (US)

(21) Appl. No.: 16/560,553

(22) Filed: Sep. 4, 2019

(51) Int. Cl. H01B 11/18; H01B 11/00

(52) U.S. Cl. CPC H01B 11/1808; H01B 11/002

(57) ABSTRACT

An electrical cable includes a conductor assembly. The conductor assembly has a first conductor, a second conductor, and an insulator structure surrounding the first conductor and the second conductor. The first and second conductors carry differential signals. The insulator structure has an outer surface. The electrical cable includes a cable shield wrapped around the conductor assembly to form a longitudinal seam that extends a length of the electrical cable. The cable shield engages the outer surface of the insulator structure. The cable shield has a single shield layer as an overall shield covering for the conductor assembly. The cable shield does not include a sealing tape wrapped therearound.

### BACKGROUND OF THE INVENTION

The subject matter herein relates generally to electrical cables that provide shielding around signal conductors.

Shielded electrical cables are used in high-speed data transmission applications in which electromagnetic interference (EMI) and/or radio frequency interference (RFI) are concerns. Electrical signals routed through shielded cables may radiate less EMI/RFI emissions to the external environment than electrical signals routed through non-shielded cables. In addition, the electrical signals being transmitted through the shielded cables may be better protected against interference from environmental sources of EMI/RFI than signals through non-shielded cables.

Shielded electrical cables are typically provided with a pair of signal conductors conveying differential signals. The signal conductors are surrounded by an insulator. A longitudinal wrapped cable shield surrounds the insulator and a sealing tape is helically wrapped around the cable shield. The sealing tape forms part of the shielding structure. The sealing tape includes overlapping regions arranged at a predetermined pitch along the length of the electrical cable that form periodic reflections in the shield structure along the length of the electrical cable. The periodic reflections worsen insertion loss and mode conversion of the electrical cable, thus negatively impacting signal integrity performance of the electrical cable. To overcome the effects of the periodic reflections, the pitch of the helical wrappings and the amount of overlap of the overlapping regions may be controlled to adjust affected frequencies (known as suck out adjustment). For example, the affected frequencies may be adjusted to frequencies beyond the frequency band of use of the particular electrical cable. However, such adjustments are limited and ineffective in higher speed electrical cables.

A need remains for an electrical cable that improves signal performance.

### BRIEF DESCRIPTION OF THE INVENTION

In one embodiment, an electrical cable is provided. The electrical cable includes a conductor assembly. The conductor assembly has a first conductor, a second conductor, and an insulator structure surrounding the first conductor and the second conductor. The first and second conductors carry differential signals. The insulator structure has an outer surface. The electrical cable includes a cable shield wrapped around the conductor assembly to form a longitudinal seam that extends a length of the electrical cable. The cable shield engages the outer surface of the insulator structure. The cable shield has a single shield layer as an overall shield covering for the conductor assembly, wherein the cable shield does not include a sealing tape wrapped therearound.

In another embodiment, an electrical cable is provided. The electrical cable includes a conductor assembly. The conductor assembly has a first conductor, a second conductor, and an insulator structure surrounding the first conductor and the second conductor. The first and second conductors carry differential signals. The insulator structure has an outer surface. The electrical cable includes a cable shield wrapped around the conductor assembly to form a longitudinal seam that extends a length of the electrical cable. The cable shield engages the outer surface of the insulator structure. The cable shield has a shield layer without periodic reflections along an entire length of the electrical cable.

In a further embodiment, a cable assembly is provided. The cable assembly includes a first electrical cable. The first electrical cable includes a first conductor assembly and a first cable shield wrapped around the first conductor assembly. The first conductor assembly has a first conductor, a second conductor, and a first insulator structure surrounding the first conductor and the second conductor. The first and second conductors carry differential signals. The first insulator structure has a first outer surface. The first cable shield forms a longitudinal seam that extends a length of the first electrical cable. The first cable shield engages the first outer surface of the first insulator structure. The first cable shield has a single shield layer as an overall shield covering for the first conductor assembly. The cable assembly includes a second electrical cable. The second electrical cable includes a second conductor assembly and a second cable shield wrapped around the second conductor assembly. The second conductor assembly has a third conductor, a fourth conductor, and a second insulator structure surrounding the third conductor and the fourth conductor. The third and fourth conductors carry differential signals. The second insulator structure has a second outer surface. The second cable shield forms a longitudinal seam extending a length of the second electrical cable. The second cable shield engages the second outer surface of the second insulator structure. The second cable shield has a single shield layer as an overall shield covering for the second conductor assembly. The cable assembly includes a jacket surrounding the first and second electrical cables. The first cable shield engages the second cable shield within the jacket.

### BRIEF DESCRIPTION OF THE DRAWINGS

FIG. 1 is a perspective view of a portion of an electrical cable formed in accordance with an embodiment.

FIG. 2 is a perspective view of a prior art conventional electrical cable in accordance with an exemplary embodiment.

FIG. 3 is a cross-sectional view of a conductor assembly of the electrical cable shown in FIG. 1 in accordance with an exemplary embodiment.

FIG. 4 is a cross-sectional view of a conductor assembly according to another exemplary embodiment.

### DETAILED DESCRIPTION OF THE INVENTION

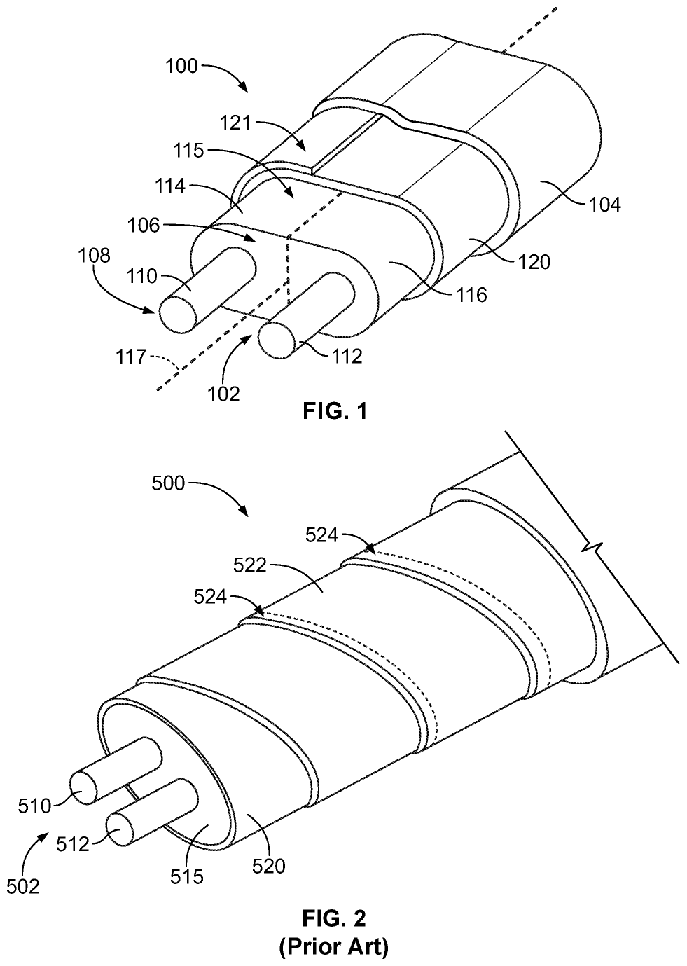

FIG. 1 is a perspective view of a portion of an electrical cable 100 formed in accordance with an embodiment. The electrical cable 100 may be used for high speed data transmission between two electrical devices, such as electrical switches, routers, and/or host bus adapters. For example, the electrical cable 100 may be configured to transmit data signals at speeds of at least 10 gigabits per second (Gbps), which is required by numerous signaling standards, such as the enhanced small form-factor pluggable (SFP+) standard. For example, the electrical cable 100 may be used to provide a signal path between high speed connectors that transmit data signals at high speeds. In various embodiments, a plurality of electrical cables 100 may be bundled together as a cable bundle, such as within a common outer jacket.

The electrical cable 100 includes a conductor assembly 102. In various embodiments, the conductor assembly 102 is held within an outer jacket 104 of the electrical cable 100 that surrounds the conductor assembly 102 along a length of the conductor assembly 102. In other various embodiments, the electrical cable 100 is provided without the outer jacket 104. In FIG. 1, the conductor assembly 102 is shown protruding from the outer jacket 104 for clarity in order to illustrate the various components of the conductor assembly 102 that would otherwise be obstructed by the outer jacket 104. The outer jacket 104 may be stripped away from the conductor assembly 102 at a distal end of the cable 100 to allow for the conductor assembly 102 to terminate to an electrical connector, a printed circuit board, or the like.

In an exemplary embodiment, the conductor assembly 102 is a twin-axial differential pair conductor assembly. For example, the conductor assembly 102 includes inner conductors in a cable core 106 of the conductor assembly 102 arranged as a pair 108 configured to convey differential data signals. The pair 108 of conductors includes a first conductor 110 and a second conductor 112. In an exemplary embodiment, the conductor assembly 102 includes an insulator structure 115 surrounding the conductors 110, 112. The conductor assembly 102 includes a cable shield 120 surrounding the conductor assembly 102 and providing electrical shielding for the conductors 110, 112. The conductors 110, 112, the insulator structure 115, and the cable shield 120 extend along a cable axis 117 of the electrical cable 100.

The insulator structure 115 includes a first insulator 114 and a second insulator 116 surrounding the first and second conductors 110, 112, respectively. In various embodiments, the insulator structure 115 is a monolithic, unitary insulator surrounding both conductors 110, 112. For example, the first and second insulators 114, 116 may be formed by extruding the insulator structure 115 with both conductors 110, 112 simultaneously. The monolithic insulator structure 115 may be elliptical or oval shaped, such as shown in the illustrated embodiment. In other various embodiments, the first and second insulators 114, 116 may be separately extruded with and surround the first and second conductors 110, 112, respectively, defining a multi-piece insulator structure 115. The separate first and second insulators 114, 116 may be combined together within the cable core 106 of the electrical cable 100. In such embodiments, the first and second insulators 114, 116 may be cylindrical insulators arranged within the same cable core 106 and surrounded by the cable shield 120.

The conductors 110, 112 extend longitudinally along the length of the cable 100. The conductors 110, 112 are formed of a conductive material, for example a metal material, such as copper, aluminum, silver, or the like. Each conductor 110, 112 may be a solid conductor or alternatively may be composed of a combination of multiple strands wound together. The conductors 110, 112 extend generally parallel to one another along the cable axis 117 for the entire length of the electrical cable 100.

The insulator structure 115 surrounds and engages the first and second conductors 110, 112. As used herein, two components “engage” or are in “engagement” when there is direct physical contact between the two components. The insulator structure 115 is formed of a dielectric material, for example one or more plastic materials, such as polyethylene, polypropylene, polytetrafluoroethylene, or the like. The insulator structure 115 may be formed directly to the inner conductors 110, 112 by a molding process, such as extrusion, overmolding, injection molding, or the like. The insulator structure 115 extends between the conductors 110, 112 and the cable shield 120. The insulator structure 115 separates or spaces the conductors 110, 112 apart from one another and separates or spaces the conductors 110, 112 apart from the cable shield 120. The insulator structure 115 maintains separation and positioning of the conductors 110, 112 along the length of the electrical cable 100. The size and/or shape of the conductors 110, 112, the size and/or shape of the insulator structure 115, and the relative positions of the conductors 110, 112 and the insulator structure 115 may be modified or selected in order to attain a particular impedance for the electrical cable 100. In an exemplary embodiment, the conductors 110, 112 and/or the insulator structure 115 may be asymmetrical to compensate for skew imbalance induced by the cable shield 120 on either or both of the conductors 110, 112, such as to increase inductance in the first conductor 110, which compensates for the decrease in capacitance in the first conductor 110 due to the void near the first conductor 110 formed by wrapping the longitudinal cable shield 120 around the cable core 106.

The cable shield 120 engages and surrounds an outer perimeter of the insulator structure 115. In an exemplary embodiment, the cable shield 120 is wrapped around the insulator structure 115. For example, in an exemplary embodiment, the cable shield 120 is formed as a longitudinal wrap, otherwise known as a cigarette wrap, where a seam 121 of the wrap extends longitudinally along the entire length of the electrical cable 100. The cable shield 120 may be folded around the insulator structure 115 to form the longitudinal seam 121. The seam 121, and thus the void created by the seam 121, is in the same general radial location along the entire length of the electrical cable 100. The cable shield 120 is formed, at least in part, of a conductive material. In an exemplary embodiment, the cable shield 120 is a tape or foil configured to be folded around the insulator structure 115. For example, the cable shield 120 may include a multi-layer tape having a conductive layer, an insulating layer, such as a backing layer, and an adhesive layer used to secure the cable shield 120 to the insulator structure 115. In various embodiments, the conductive layer and the backing layer may be secured together by an adhesive layer. In other various embodiments, the backing layer may be applied to the conductive layer by a physical vapor deposition (PVD) process, for example. The conductive layer may be a conductive foil or another type of conductive layer. The insulating layer may be a thermoplastic layer, such as a polyethylene terephthalate (PET) film, or similar type of film. The conductive layer provides both an impedance reference layer and electrical shielding for the first and second conductors 110, 112 from external sources of EMI/RFI interference and/or to block cross-talk between other conductor assemblies 102 or electrical cables 100. The adhesive layer(s) may be heat activated. For example, the conductor assembly 102 and the cable shield 120 may be passed through a heater or a heated die to activate the adhesive layer to secure the cable shield 120 to the conductor assembly 102. Optionally, the cable shield 120 may be applied under vacuum to remove air between the cable shield 120 and the conductor assembly 102.

In an exemplary embodiment, the cable shield 120 has a single shield layer that forms an overall shield covering for the conductor assembly 102. The cable shield 120 does not include an additional sealing tape wrapped around an exterior of the cable shield 120, as is typical of conventional electrical cables. For example, FIG. 2 is a perspective view of a prior art conventional electrical cable 500 including a conductor assembly 502 having an insulator structure 515 surrounding first and second conductors 510, 512, a cable shield 520 surrounding the insulator structure 515, and a sealing tape 522 wrapped around the cable shield 520. The sealing tape 522 is provided outside of the cable shield 520 and forms part of the shield structure. The sealing tape 522 is wrapped helically around the cable shield 520 to secure the cable shield 520 on the insulator structure 515. The sealing tape has overlapping regions 524 arranged at a predetermined pitch along the length of the electrical cable 500. The overlapping regions form periodic reflections in the shield structure along the length of the electrical cable 500, which contribute to worsen insertion loss and mode conversion and thus negatively impact signal integrity performance of the electrical cable 500. While the pitch of the helical wrap of the sealing tape 522 and the amount of overlap of the overlapping regions 524 may be selected to adjust affected frequencies (known as suck out adjustment), such adjustments are limited and ineffective in higher speed electrical cables.

In an exemplary embodiment, the electrical cable 100 does not include any sealing tape wrapped around the cable shield 120. The electrical cable 100 does not include a helically wrapped metal structure exterior of the insulator structure 115, rather only includes the longitudinally wrapped cable shield 120 to define the shield structure for the conductors 110, 112. The shield structure is without periodic reflections along an entire length of the electrical cable 100 because the cable shield 120 is longitudinally wrapped rather than being helically wrapped and thus does not include any periodic overlapping regions as is typical of the sealing tape 522 of the conventional electrical cable 500. The cable shield 120 defines an outermost surface of the electrical cable 100 and does not include any additional helical wrap around the outside of the cable shield 120 as is present in the conventional electrical cable 500 with the sealing tape 522. The longitudinal seam 121 extends along the outermost surface of the electrical cable 100. In an exemplary embodiment, the cable shield 120 is fused directly to the insulator structure 115 and thus does not need an additional securing structure, such as a helically wrapped sealing tape to secure the cable shield 120 to the insulator structure 115.

In an exemplary embodiment, the outer jacket 104 is devoid of metal and thus does not define part of the shielding structure. In embodiments utilizing the outer jacket 104, the outer jacket 104 surrounds and engages the outer perimeter of the cable shield 120. In the illustrated embodiment, the outer jacket 104 engages the cable shield 120 along substantially the entire periphery of the cable shield 120. The outer jacket 104 is formed of at least one dielectric material, such as one or more plastics (for example, vinyl, polyvinyl chloride (PVC), acrylonitrile butadiene styrene (ABS), or the like). The outer jacket 104 is non-conductive, and is used to insulate the cable shield 120 from objects outside of the electrical cable 100. The outer jacket 104 also protects the cable shield 120 and the other internal components of the electrical cable 100 from mechanical forces, contaminants, and elements (such as fluctuating temperature and humidity). Optionally, the outer jacket 104 may be extruded or otherwise molded around the cable shield 120. Alternatively, the outer jacket 104 may be wrapped around the cable shield 120 or heat shrunk around the cable shield 120.

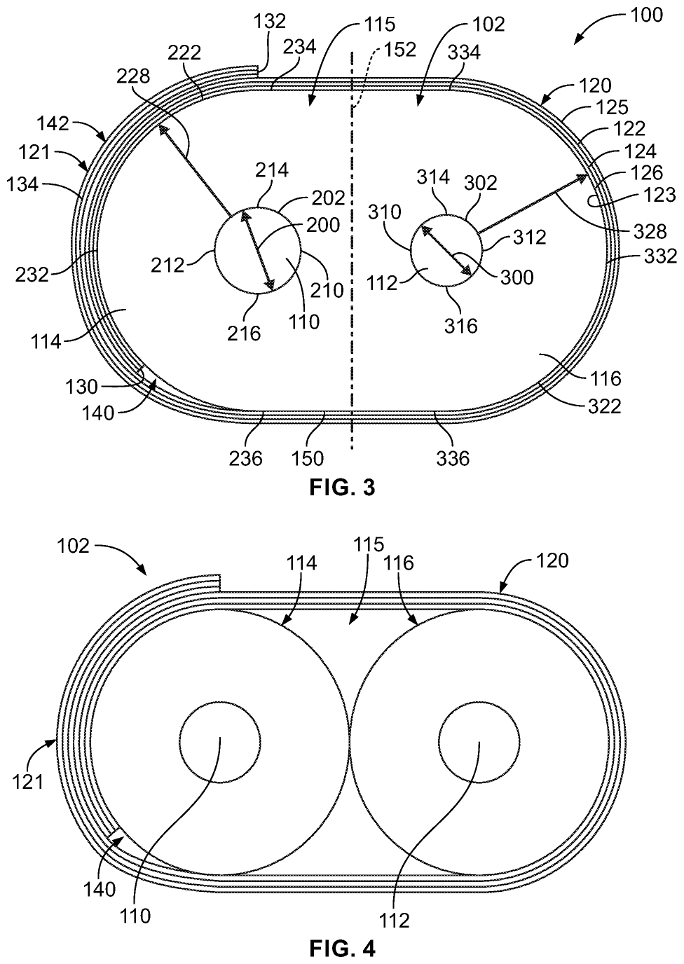

FIG. 3 is a cross-sectional view of the conductor assembly 102 in accordance with an exemplary embodiment. The cable shield 120 is wrapped around the insulator structure 115 in the cable core 106. The cable shield 120 is a layered structure including one or more conductive layers 122, one or more insulating layers 124, and one or more adhesive layers 126. The conductive layer 122 defines a shield layer for the conductor assembly 102. In various embodiments, the cable shield 120 may be a tape having a metallic foil with polymer backer to increase mechanical strength of the thin metallic foil.

In the illustrated embodiment, the adhesive layer 126 is provided at an interior 123 of the cable shield 120 and the conductive layer 122 is provided at an exterior 125 of the cable shield 120. The adhesive layer 126 is provided directly on the insulating structure 115 and is used to secure the cable shield 120 to the insulating structure 115. In various embodiments, the insulating structure 115 may be pre-treated or have an adhesive layer to bond with the cable shield 120, such as to the adhesive layer 126 or the conductive layer 122. Optionally, the cable shield 120 may be provided without the adhesive layer 126, rather applying the conductive layer 122 to the adhesive layer on the insulating structure 115. In various embodiments, the insulating layer 124 is provided directly on the adhesive layer 126. The conductive layer 122 is provided directly on the insulating layer 124 (such as with an adhesive layer between the conductive layer 122 and the insulating layer 124 or with the insulating layer 124 applied to the conductive layer by a PVD process). Other arrangements are possible in alternative embodiments, such as providing the conductive layer 122 directly on the adhesive layer 126 and providing the insulating layer 124 directly on the conductive layer 122. In other various embodiments, insulating layers 124 may be provided on both sides of the conductive layer 122, such as having an inner PET layer, an aluminum layer, and an outer PET layer with the adhesive layer 126 applied to the inner PET layer (adhesive layers may be provided between the PET layers and the aluminum layer).

The cable shield 120 includes an inner edge 130 and an outer edge 132. When the cable shield 120 is wrapped around the cable core 106, a flap 134 of the cable shield 120 overlaps the inner edge 130 and a segment 142 of the cable shield 120 on a side of the electrical cable 100. The overlapping portion of the cable shield 120 forms the longitudinal seam 121 along the side of the electrical cable 100. In other various embodiments, the longitudinal seam 121 may be centered along the top or the bottom of the electrical cable 100 rather than being provided at the side of the electrical cable 100. The interior 123 of the flap 134 may be secured to the exterior 125 of the segment 142 at the seam 121 using the adhesive layer 126. The interior 123 of the cable shield 120 is secured directly to the insulator structure 115 using the adhesive layer 126.

In an exemplary embodiment, the insulator structure 115 is manufactured from a high heat deflection temperature dielectric and the adhesive layer 126 is manufactured from a high activation temperature adhesive. The heat deflection temperature is the temperature at which the dielectric material deforms and changes shape. An activation temperature of the high activation temperature adhesive of the adhesive layer 126 is lower than the heat deflection temperature of the high extrusion temperature dielectric of the insulator structure 115. As such, the adhesive layer 126 is activated at a temperature below the heat deflection temperature such that the insulator structure 115 is not deformed when the adhesive layer 126 is activated. During manufacture, the conductor assembly 102 is processed through an extrusion machine to form the insulator structure 115. The conductor assembly 102 is cooled to cure or set the insulator structure 115. The cable shield 120 is then longitudinally wrapped around the insulator structure 115. The conductor assembly 102 and the cable shield 120 are passed through a heated die, which heats the adhesive layer 126 of the cable shield 120 to a temperature in excess of the activation temperature of the adhesive, causing the adhesive to activate and adhere to the insulator structure 115. The assembly may be passed through a cooling module, such as a freezer unit to cool the assembly and set the adhesive to join the adhesive to the insulator structure 115, thus securing the cable shield 120 directly to the insulator structure 115 without the need for an additional sealing wrap. In an exemplary embodiment, the activation temperature of the adhesive layer 126 is higher than an extrusion temperature of the outer jacket 104 such that the adhesive layer 126 does not activate or melt during the extrusion of the outer jacket 104.

When the cable shield 120 is longitudinally wrapped over itself to form the flap 134, a void 140 is created at the seam 121 of the electrical cable 100. The void 140 may be along the side or along the top or the bottom of the electrical cable 100. In various embodiments, the void 140 is a pocket of air defined between the interior 123 of an elevated segment 142 of the cable shield 120 and the insulator structure 115, such as at the first insulator 114. The void 140 may be referred to hereinafter as an air void 140. However, in other various embodiments, the void 140 may be filled with another material, such as adhesive or other dielectric material. The elevated segment 142 is elevated or lifted off of the first insulator 114 to allow the flap 134 to clear the inner edge 130. The air void 140 extends longitudinally along the entire length of the electrical cable 100 at the seam 121.

In FIG. 3, the insulator structure 115 is one integral, monolithic member that surrounds and extends between the first and second conductors 110, 112. For example, the conductor assembly 102 may be formed by molding, extruding or otherwise applying the material of the insulator structure 115 to the first and second conductors 110, 112 at the same time. In various embodiments, the first and second conductors 110, 112 have a circular cross-section. However, the first and second conductors 110, 112 may have other cross-sectional shapes, such as a square shape. The conductor assembly 102 forms a twin-axial insulated core, and the cable shield 120 is applied around the twin-axial insulated core. In various embodiments, the outer perimeter of the insulator structure 115 may have a generally elliptical or oval shape. For example, the insulator structure 115 may be elongated side-to-side and narrow top-to-bottom. It is recognized that the insulator structure 115 need not have the elliptical shape in other embodiments.

The cable shield 120 generally conforms to the insulator structure 115, except at the void 140. In an embodiment, the cross-sectional shape of the cable shield 120 is geometrically similar to the cross-sectional shape of the outer perimeter of the insulator structure 115. The term “geometrically similar” is used to mean that two objects have the same shape, although different sizes, such that one object is scaled relative to the other object. As shown in FIG. 3, the outer perimeter of the cable shield 120 has a generally elliptical or oval shape along the cross-section (other than at the void 140), which is similar to the outer perimeter of the insulator structure 115.

The insulator structure 115 has an outer surface 150. The cable shield 120 is applied to the outer surface 150. The material of the insulator structure 115 closer to the first conductor 110 insulates the first conductor 110 from the second conductor 112 and from the cable shield 120 and thus defines the first insulator 114. The material of the insulator structure 115 closer to the second conductor 112 insulates the second conductor 112 from the first conductor 110 and from the cable shield 120 and thus defines the second insulator 116.

In an exemplary embodiment, the shape of the insulator structure 115 may be symmetrical about a bisector axis 152 between the first and second conductors 110, 112. In the illustrated embodiment, the bisector axis 152 is oriented vertically along the minor axis of the insulator structure 115. The first and second insulators 114, 116 of the insulator structure are defined on opposite sides of the bisector axis 152 centered between opposite outer ends of the insulator structure 115. The first and second insulators 114, 116 may be symmetrical about the bisector axis 152. For example, the first and second insulators 114, 116 may be mirrored about the bisector axis 152. The bisector axis 152 is located between the first and second conductors 110, 112.

In an exemplary embodiment, the first conductor 110 has a first conductor outer surface 202 having a circular cross-section having a first diameter 200. The first conductor 110 has an inner end 210 facing the second conductor 112 and an outer end 212 opposite the inner end 210. The first conductor 110 has a first side 214 (for example, a top side) and a second side 216 (for example, a bottom side) opposite the first side 214. The first and second sides 214, 216 are equidistant from the inner and outer ends 210, 212.

In an exemplary embodiment, the first insulator 114 surrounds the first conductor 110 and has a first insulator outer surface 222, defining a portion of the outer surface 150 of the insulator structure 115. A thickness of the first insulator 114 between the first conductor 110 and the first insulator outer surface 222 defines a first shield distance 228 between the first conductor 110 and the cable shield 120. Optionally, the shield distance 228 may be variable. For example, the shield distance 228 between the outer end 212 of the first conductor 110 and the cable shield 120 may be different (for example, less than) the shield distance 228 between the first side 214 and the cable shield 120 and/or the second side 216 and the cable shield 120. The first insulator 114 has an outer end 232 opposite the second insulator 116 and the bisector axis 152. The first insulator 114 has a first side 234 (for example, a top side) and a second side 236 (for example, a bottom side) opposite the first side 234. In various embodiments, the first and second sides 234, 236 are equidistant from the outer end 232. The first insulator 114 may be curved between the outer end 232 and the first side 234 and then extend from the first side 234 to the bisector axis 152 along a linear path generally perpendicular to the bisector axis 152. Similarly, the first insulator 114 may be curved between the outer end 232 and the second side 236 and then extend from the second side 236 to the bisector axis 152 along a linear path generally perpendicular to the bisector axis 152. For example, the top and the bottom of the insulator structure 115 may be flat and parallel to each other while the sides of the insulator structure 115 (for example, at the outer end 232) may be curved. In other various embodiments, the top and the bottom of the insulator structure 115 may be curved rather than being flat.

The shield distance 228 between the cable shield 120 and the first conductor 110 is defined by the thickness of the first insulator 114. The shield distance 228 affects the electrical characteristics of the signals transmitted by the first conductor 110. For example, the shield distance 228 affects the inductance and the capacitance of the first conductor 110, which affects the delay or skew of the signal, the insertion loss of the signal, the return loss of the signal, and the like. In an exemplary embodiment, the shield distance 228 may be controlled or selected, such as by selecting the position of the first conductor 110 within the first insulator 114.

In an exemplary embodiment, the second conductor 112 has a second conductor outer surface 302 having a circular cross-section having a second diameter 300. The second conductor 112 has an inner end 310 facing the first conductor 110 and an outer end 312 opposite the inner end 310. The second conductor 112 has a first side 314 (for example, a top side) and a second side 316 (for example, a bottom side) opposite the first side 314. The first and second sides 314, 316 are equidistant from the inner and outer ends 310, 312.

In an exemplary embodiment, the second insulator 116 surrounds the second conductor 112 and has a second insulator outer surface 322, defining a portion of the outer surface 150 of the insulator structure 115. A thickness of the second insulator 116 between the second conductor 112 and the second insulator outer surface 322 defines a second shield distance 328 between the second conductor 112 and the cable shield 120. Optionally, the shield distance 328 may be generally uniform between the cable shield 120 and the outer end 312 and the first and second sides 314, 316. The second insulator 116 has an outer end 332 opposite the first insulator 114 and the bisector axis 152. The second insulator 116 has a first side 334 (for example, a top side) and a second side 336 (for example, a bottom side) opposite the first side 334. In various embodiments, the first and second sides 334, 336 are equidistant from the outer end 332. The second insulator 116 may be curved between the outer end 332 and the first side 334 and then extend from the first side 334 to the bisector axis 152 along a linear path generally perpendicular to the bisector axis 152. Similarly, the second insulator 116 may be curved between the outer end 332 and the second side 336 and then extend from the second side 336 to the bisector axis 152 along a linear path generally perpendicular to the bisector axis 152. For example, the top and the bottom of the insulator structure 115 may be flat and parallel to each other while the sides of the insulator structure 115 (for example, at the outer end 332) may be curved. In other various embodiments, the top and the bottom of the insulator structure 115 may be curved rather than being flat. The cable shield 120 engages the second insulator outer surface 322. In the illustrated embodiment, the second segment 340 does not include any void like the void 140.

FIG. 4 is a cross-sectional view of the conductor assembly 102 according to another exemplary embodiment. In the alternative embodiment shown in FIG. 4, the insulator structure 115 is defined by separate and discrete first and second insulators 114, 116. The outer perimeter of the insulator structure 115 is defined by the combination of the two circular insulators 114, 116.

The cable shield 120 is coupled to the first and second insulators 114, 116 such that the cable shield 120 wraps around both of the first and second insulators 114, 116. The cable shield 120 has an oval shape similar to the shape of the cable shield 120 shown in FIG. 3. The cable shield 120 includes the void 140 along the longitudinal seam 121. In an exemplary embodiment, the electrical cable 100 does not include any sealing tape wrapped around the cable shield 120. The electrical cable 100 does not include a helically wrapped metal structure exterior of the insulator structure 115, rather only includes the longitudinally wrapped cable shield 120 to define the shield structure for the conductors 112, 114. The shield structure is without periodic reflections along an entire length of the electrical cable 100 because the cable shield 120 is longitudinally wrapped rather than being helically wrapped and thus does not include any periodic overlapping regions as is typical of the sealing tape 522 (shown in FIG. 2) of the conventional electrical cable 500 (shown in FIG. 2). The cable shield 120 defines an outermost surface of the electrical cable 100 and does not include any additional helical wrap around the outside of the cable shield 120. The longitudinal seam 121 extends along the outermost surface of the electrical cable 100. In an exemplary embodiment, the cable shield 120 is fused directly to the first and second insulators 114, 116 of the insulator structure 115 and thus does not need an additional securing structure, such as a helically wrapped sealing tape to secure the cable shield 120 to the insulator structure 115.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. An electrical cable comprising:
a conductor assembly having a first conductor, a second conductor, and an insulator structure surrounding the first conductor and the second conductor, the first and second conductors carrying differential signals, the insulator structure having an outer surface; and
a cable shield wrapped around the conductor assembly forming a longitudinal seam extending a length of the electrical cable parallel to a cable axis of the electrical cable, the cable shield engaging the outer surface of the insulator structure and being secured to the outer surface of the insulator structure by adhesive, the cable shield having a single shield layer as an overall shield covering for the conductor assembly, wherein the cable does not include a sealing tape wrapped around the cable shield.

2. The electrical cable of claim 1, wherein the cable shield is without periodic reflections along an entire length of the electrical cable.

3. The electrical cable of claim 1, wherein the cable shield includes an outer shield surface defining an outermost surface of the electrical cable.

4. The electrical cable of claim 1, wherein the longitudinal seam extends along an outermost surface of the electrical cable.

5. The electrical cable of claim 1, wherein the longitudinal seam does not wrap helically around the electrical cable.

6. The electrical cable of claim 1, wherein the cable shield includes an adhesive layer, the adhesive layer being secured to the outer surface of the insulator structure.

7. The electrical cable of claim 1, wherein the cable shield includes a layered structure comprising an adhesive layer directly on the outer surface of the insulator structure, a PET layer directly on the adhesive layer, and a metal layer forming the single shield layer directly on the PET layer.

8. The electrical cable of claim 1, wherein the cable shield includes a layered structure comprising an adhesive layer directly on the outer surface of the insulator structure, a metal layer forming the single shield layer directly on the adhesive layer, and a PET layer directly on the metal layer.

9. The electrical cable of claim 1, wherein the cable shield includes an inner edge and a flap covering the inner edge, the flap forming the seam, the cable shield forming a void at the inner edge.

10. The electrical cable of claim 1, wherein the insulator structure is manufactured from a high heat deflection temperature dielectric and the cable shield includes an adhesive layer manufactured from a high activation temperature adhesive, wherein an activation temperature of the adhesive of the adhesive layer is lower than a heat deflection temperature of the dielectric of the insulator structure.

11. The electrical cable of claim 1, wherein the cable shield is fused directly to the insulator structure.

12. The electrical cable of claim 1, wherein the electrical cable does not include a helically wrapped metal structure exterior of the insulator structure.

13. An electrical cable comprising:
a conductor assembly having a first conductor, a second conductor, and an insulator structure surrounding the first conductor and the second conductor, the first and second conductors carrying differential signals, the insulator structure having an outer surface; and
a cable shield wrapped around the conductor assembly forming a longitudinal seam extending a length of the electrical cable, the cable shield engaging the outer surface of the insulator structure and being secured to the outer surface of the insulator structure by adhesive, the cable being without periodic reflections along the cable shield for an entire length of the electrical cable.

14. The electrical cable of claim 13, wherein the shield layer is a single shield layer being an overall shield covering for the conductor assembly.

15. The electrical cable of claim 13, wherein the cable shield includes an outer shield surface defining an outermost surface of the electrical cable.

16. The electrical cable of claim 13, wherein the cable shield does not include a sealing tape wrapped therearound

17. A cable assembly comprising:
a first electrical cable comprising a first conductor assembly and a first cable shield wrapped around the first conductor assembly, the first conductor assembly having a first conductor, a second conductor, and a first insulator structure surrounding the first conductor and the second conductor, the first and second conductors carrying differential signals, the first insulator structure having a first outer surface, the first cable shield forming a longitudinal seam extending a length of the first electrical cable, the first cable shield engaging the first outer surface of the first insulator structure and being secured to the first outer surface of the first insulator structure by adhesive, the first cable shield having a single shield layer as an overall shield covering for the first conductor assembly; and
a second electrical cable comprising a second conductor assembly and a second cable shield wrapped around the second conductor assembly, the second conductor assembly having a third conductor, a fourth conductor, and a second insulator structure surrounding the third conductor and the fourth conductor, the third and fourth conductors carrying differential signals, the second insulator structure having a second outer surface, the second cable shield forming a longitudinal seam extending a length of the second electrical cable, the second cable shield engaging the second outer surface of the second insulator structure and being secured to the second outer surface of the second insulator structure by adhesive, the second cable shield having a single shield layer as an overall shield covering for the second conductor assembly;
a jacket surrounding the first and second electrical cables, the first cable shield engaging the second cable shield within the jacket.

18. The cable assembly of claim 17, wherein the first cable shield is without periodic reflections along an entire length of the first electrical cable, and wherein the second cable shield is without periodic reflections along an entire length of the second electrical cable.

19. The cable assembly of claim 17, wherein the first cable shield does not include a sealing tape wrapped therearound, and wherein the second cable shield does not include a sealing tape wrapped therearound.

20. The cable assembly of claim 17, wherein the first cable shield includes a first outer shield surface defining an outermost surface of the first electrical cable, the second cable shield including a second outer shield surface defining an outermost surface of the second electrical cable, the first outer shield surface engaging the second outer shield surface.
